(19) United States
(12) Patent Application Publication
(10) Pub. No.: US 2017/0227148 A1
(43) Pub. Date: Aug. 10, 2017

(54) HOSE LINE FOR A FLUID AND METHOD FOR PRODUCING SUCH A HOSE LINE

(71) Applicant: Veritas AG, Gelnhausen (DE)

(72) Inventors: Marc Van Hooren, Freigericht (DE); Wilfried Zulch, Gelnhausen (DE); Volker Schulz, Wächtersbach (DE)

(21) Appl. No.: 15/411,683

(22) Filed: Jan. 20, 2017

(30) Foreign Application Priority Data
Feb. 10, 2016 (DE) 10 2016 100 668.6
Feb. 10, 2016 (DE) 10 2016 102 303.5

(51) Int. Cl. F16L 11/127; H05F 3/04

(52) U.S. Cl. CPC F16L 11/127; H05F 3/04

(57) ABSTRACT

The present disclosure relates to a hose line for a fluid comprising a support layer, a first barrier layer configured to prevent the diffusion of the fluid, and a second barrier layer, wherein the first barrier layer is arranged on the internal side of the hose line and the second barrier layer is arranged between the first barrier layer and the support layer. The present disclosure further relates to a method for producing a hose line.

### CROSS-REFERENCE TO RELATED APPLICATIONS

This application claims priority to German patent application No. 10 2016 102 303.5, entitled “Schlauchleitung für ein Fluid und Verfahren zum Herstellen einer solchen Schlauchleitung”, and filed on Feb. 10, 2016 by the Applicant of this application, and to German patent application No. 20 2016 100 668.6, entitled “Schlauchleitung für ein Fluid”, and filed on Feb. 10, 2016 by the Applicant of this application. The entire disclosure of both German applications is incorporated herein by reference for all purposes.

### BACKGROUND

The present disclosure relates to a hose line for a fluid and a method for producing such a hose line.

Hose lines for conducting fuels in vehicles are known in the prior art. These lines comprise a support layer in order to achieve a required mechanical strength, e.g. against tensile loads or fuel pressure, and to protect the hose line from external mechanical damage. In addition to the support layer, they frequently also comprise a barrier layer to prevent fuel from being able to diffuse through the wall of the hose line to the extent that the support layer itself does not adequately prevent diffusion.

Regulatory requirements such as, for example the American PZEV/SULEV standards, require effective protection against the diffusion of fuels into the environment from the components of a motor vehicle, and thus also the hose lines for conducting fuels.

It is thus the task of the present disclosure to provide a hose line that enables improved protection against diffusion of a fluid flowing through the hose line without compromising the mechanical or dynamic properties of the hose line as well as to provide a method for producing such a hose line.

### SUMMARY

This task is solved by a hose line having the features of claim 1. The task is further solved by a method for producing a hose line having the features of claim 14. The subject matter of the figures, the description and the dependent claims set forth advantageous examples of the disclosure.

According to a first aspect of the disclosure, the task is solved by a hose line for a fluid comprising a support layer, a first barrier layer, in particular of a first material, which is configured to prevent diffusion of the fluid through the wall of the hose line, and a second barrier layer, in particular of a second material, wherein the first barrier layer is arranged on the internal side of the hose and the second barrier layer is arranged between the first barrier layer and the support layer.

The barrier layers are thereby configured so as to be able to effectively prevent fluid from diffusing through the wall of the hose line; i.e. they have very low permeability with respect to the fluid conveyed through the hose line. The support layer, on the other hand, primarily ensures the mechanical stability of the hose line, e.g. against compressive or tensile load as well as against external mechanical influences which could lead to hose line damage. The support layer can, however, exhibit a higher fluid permeability than the harrier layers.

In the implementation according to the disclosure, the support layer is arranged on the external side of the hose line; i.e. the side facing the environment, whereas one of the barrier layers is arranged on the internal side of the hose line; i.e. the side facing the conveyed fluid. Doing so thus prevents the fluid from diffusing through the wall of the hose line and reaching the support layer, which could result in corrosion or degradation of the support layer's mechanical strength. This arrangement enables selecting a material for the support layer that although exhibits the desired mechanical properties, is not necessarily resistant to the fluid being conveyed in the hose line. Since the support layer ensures the necessary mechanical properties, the barrier layers can be largely or exclusively optimized to prevent diffusion, even though they can be of very thin configuration and only need be of limited mechanical strength.

Arranging two barrier layers adjacently can realize optimal protection against diffusion. This is in particular possible when the two barrier layers are made of different materials. In this case, the two barrier layers can for example also be respectively optimized in terms of the diffusion relative to different constituents of the fluid to be conveyed; i.e. one barrier layer prevents the diffusion of some constituents while the other barrier layer prevents the diffusion of other constituents against which the first barrier layer has less of a barrier effect. The adjacent arrangement of two barrier layers further enables the use of a support layer that although can adequately adhere mechanically to the material of one of the barrier layers during production, cannot adequately adhere to the material of the other barrier layer. The barrier layer arranged in between thus acts as an adhesion agent between the other barrier layer and the support layer.

In a further advantageous example, the first barrier layer arranged on the internal side of the hose is electrically conductive. This can be realized by using a conductive material or by embedding electrically conductive particles, for example carbon black or other carbon particles, into the material of the barrier layer. The electrical conductivity enables the discharging of electrical charges, which can occur for example due to electrostatic charge, e.g. during fueling. Among other things, the electrical conductivity thereby achieves effective protection against sparking. By having the barrier layer which is arranged on the internal side of the hose; i.e. in direct contact with the fluid, be electrically conductive, electrical charges can be discharged directly from the fluid.

In a further advantageous example, the hose line further comprises an electrically conductive strip for discharging electrical charge being arranged on the internal side of the hose. A barrier layer of electrically non-conductive material can thus be used as the barrier layer arranged on the internal side of the hose line and the discharge of electrical charges realized by an electrically conductive strip. This strip can consist of a metallic material although also of an electrically conductive plastic. Although one strip can hereby be provided, a plurality of strips, for example four, can also be provided, said strips being evenly distributed over the circumference of the hose line's internal side.

In a further advantageous example, the layer arranged on the internal side of the hose comprises a recess for accommodating the electrically conductive strip. In so doing, the electrically conductive strip does not protrude into the interior of the hose line, the internal side instead exhibiting a substantially smooth wall. More favorable hose line properties in terms of fluid mechanics can thus be achieved.

In one particularly advantageous example, in addition to the support layer; i.e. a first support layer, the hose line comprises a further support layer; i.e. a second support layer, whereby the second support layer is arranged in the interior of the hose relative to the first support layer, as well as comprises an intermediate layer arranged between the first support layer and the second support layer.

Inserting an intermediate layer can further improve the mechanical properties of the hose line. For example, an intermediate layer having better pressure resistance than the support layer can be used. This thus enables for example higher fuel pressures. When making use of multiple layers, the appropriate configuration to the individual layers can optimize the mechanical properties so as to achieve optimal properties while simultaneously reducing material/weight. For example, when using an intermediate layer, one of the support layers can be of thin configuration and primarily serve as an adhesion agent between the intermediate layer and one of the barrier layers and the other support layer arranged on the external side of the hose line can likewise be of thin configuration to predominantly protect against external environmental influences, for example solely as a cover layer. The mechanical properties of the hose line are then largely determined by the intermediate layer.

In a further advantageous example, the intermediate layer is designed as a textile pressure carrier which can, for example, be braided, spiraled or knitted and can contain p-aramid, POD, polyamide, and/or PET fibers. An intermediate layer in the form of a textile pressure carrier in particular lends the hose line high compressive strength. In addition, such an intermediate layer can also increase the tensile strength and the protection against mechanical damage.

In a further advantageous example, one support layer contains an epichlorohydrin elastomer, also commercially abbreviated as ECO, an acrylate elastomer, also commercially abbreviated as ACM, or an ethylene acrylate elastomer, also commercially abbreviated as AEM. These materials can be incorporated into one of the support layers or, in an implementation having two support layers, also in both support layers. These materials can be either proportionately or predominantly incorporated into the support layers or the support layers can also consist entirely of these materials. These materials combine good mechanical properties with good processability and good adhesion to intermediate layers and barrier layers and can thus also function as an adhesion agent between the individual layers.

In a further advantageous example, one of the barrier layers predominantly comprises thermoplastic fluoroelastomer vulcanizate, also commercially abbreviated as F-TPV, and the other barrier layer predominantly comprises a fluoroelastomer (FPM). FPM or FKM respectively, both represent fluoroelastomers, while rubbers are not cross-linked and are thereby precursors for the elastomer compounds. Alternatively, one of the barrier layers can also predominantly comprise a thermoplastic fluoroelastomer, particularly fluorine TPE. These can in each case be terpolymers or copolymers. These materials afford effective protection against diffusion. The two barrier layers of the respective materials can be arranged adjacently and thereby joined such that there is sufficient adhesion between them. Using these materials enables the walls of fuel hose lines to meet the legal requirements as to the admissible diffusion of fuels. The thermoplastic fluoroelastomer vulcanizate can also be made electrically conductive by incorporating filler materials, e.g. carbon black.

In a further advantageous example, the thermoplastic fluoroelastomer vulcanizate (F-TPV) exhibits a thermoplastic matrix of fluorine resins in which areas of thermoplastic fluoroelastomer or fluororubber (FPM, FKM) have been vulcanized. A very thin barrier layer with rubber-like properties can thus be obtained.

In a further advantageous example, the barrier layer of thermoplastic fluoroelastomer vulcanizate has a layer thickness of between 0.15 mm (0.0059 in) and 3.0 mm (0.12 in) and the barrier layer of thermoplastic fluoroelastomer or fluororubber has a layer thickness of between 0.8 mm (0.031 in) and 1.5 mm (0.059 in). These layer thicknesses ensure the required protection against diffusion, whereby the layers are at the same time configured such that they have sufficient mechanical strength and adhesion of the layers is assured so that production, e.g. by means of extrusion, is readily possible without any problems.

In a further particularly advantageous example, the barrier layer of fluoroelastomer vulcanizate is arranged on the internal side of the hose line in contact with a fluid to be conveyed and thereby forms the first barrier layer, and the barrier layer of fluororubber or fluoroelastomer is arranged adjacent to the barrier layer of thermoplastic fluoroelastomer vulcanizate (F-TPV) and thereby forms the second barrier layer. The barrier layer of fluororubber or fluoroelastomer forms an adhesion system between the barrier layer of thermoplastic fluoroelastomer vulcanizate and the support layer of epichlorohydrin elastomer adjoining one of the barrier layers of fluororubber/fluoroelastomer by vulcanization.

In a further advantageous example, the electrically conductive strip has a radial thickness; i.e. toward the internal side of the hose line, of between 30 μm (0.0012 in) and 60 μm (0.0024 in). The electrical strip can thus on the one hand be embedded into the hose wall, in particular into the barrier layer arranged on the internal side. If, on the other hand, the strip is not embedded into the barrier layer arranged on the internal side, the proposed thickness then only has a slight effect on the flow inside the tube.

In accordance with a second aspect of the disclosure, a method is proposed for producing a fluid hose line according to the disclosure. As steps, the method thereby comprises providing a support layer, providing a first barrier layer configured to prevent the diffusion of the fluid, providing a second barrier layer, arranging the second harrier layer on the internal side of the support layer, arranging the first barrier layer on the internal side of the second barrier layer, as well as joining the support layer to the second barrier layer and joining the second barrier layer to the first barrier layer, particularly by vulcanization. The layers can also be joined in another way other than vulcanization, for example by means of an adhesion agent for joining the layers together. It is also conceivable to, for example, join the second barrier layer to the first support layer by adhesion and then join the first barrier layer to the second barrier layer by vulcanization.

In a further advantageous example of the method, one, multiple and, in particular, all of the layers are provided by means of extrusion. Thus, for example, the barrier layers can be produced in an extrusion process while the support layer is produced by means of another method. Preferably, however, all three cited layers are produced by extrusion. The intermediate layer in the form of a textile pressure carrier can be applied as a braided, knitted or spiraled layer.

### BRIEF DESCRIPTION OF THE DRAWINGS

The accompanying drawings will be referenced below in describing examples of the disclosure.

FIG. 1 shows a cross-sectional view of a first example of the hose line, and

FIG. 2 shows a perspective view of a further example of the hose line.

### DETAILED DESCRIPTION OF THE DRAWINGS

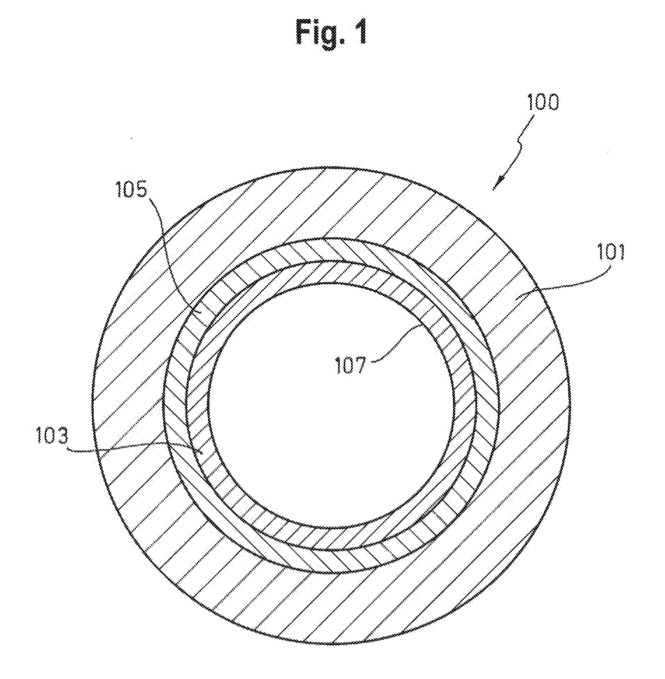

FIG. 1 shows a first example of the hose line 100 according to the disclosure in a cross-sectional view. The hose line 100 comprises a support layer 101. This layer ensures the required mechanical strength for the hose line 100, for example against tensile loads, the pressure of the fluid flowing in the hose line 100, as well as against mechanical damage attributable to external influences. The support layer 101 can for example consist of or contain an epichlorohydrin elastomer, an acrylate elastomer, or an ethylene acrylate elastomer.

A first barrier layer 103 is arranged on the internal side 107 of the hose line 100; i.e. in contact with a fluid flowing within the hose line 100. The first harrier layer 103 is resistant to the fluid and prevents the diffusion of the fluid through the first barrier layer 103, preferably to a. greater extent than the support layer 101 could prevent diffusion.

The first barrier layer 103 is preferably substantially thinner than the support layer 101. The first barrier layer 103 preferably consists entirely or predominantly of for example, thermoplastic fluoroelastomer vulcanizate or fluoroelastomer. The thermoplastic fluoroelastomer vulcanizate preferably exhibits a thermoplastic matrix of fluorine resins in which areas of fluororubber have been vulcanized.

A second barrier layer 105 is arranged between the support layer 101 and the first barrier layer 103. This prevents the further diffusion of fluid which has already diffused through the first barrier layer 103. The second barrier layer 105 can likewise consist preferably entirely or predominantly of thermoplastic fluoroelastomer vulcanizate or fluoroelastomer. In so doing, the materials of the two barrier layers 103, 105 preferably differ so that the barrier layers 103, 105 exhibit different properties, for example the second barrier layer 105 effectively preventing the diffusion of the fluid constituents which are able to diffuse through the first barrier layer 103 or the second barrier layer 105 not needing to have the same degree of resistance to the fluid as the first barrier layer 103.

In the implementation depicted in FIG. 1, the first barrier layer 103 consists of for example, thermoplastic fluoroelastomer vulcanizate (F-TPV) and the second barrier layer 105 consists of for example, fluoroelastomer (FPM). The first barrier layer 103 of thermoplastic fluoroelastomer vulcanizate hereby exhibits a layer thickness of 0.28 mm (0.011 in) and the second barrier layer 105 of fluororubber exhibits a layer thickness of 1.3 mm (0.051 in). in the implementation depicted in FIG. 1, the second barrier layer 105 of fluoroelastomer, which is arranged between the first barrier layer 103 and the support layer 101, forms an adhesion system by means of vulcanization between the first barrier layer 103 of fluoroelastomer vulcanizate and the support layer 101, formed here of epichlorohydrin elastomer, and, thereby also yields production-related advantages in addition to reduced diffusion.

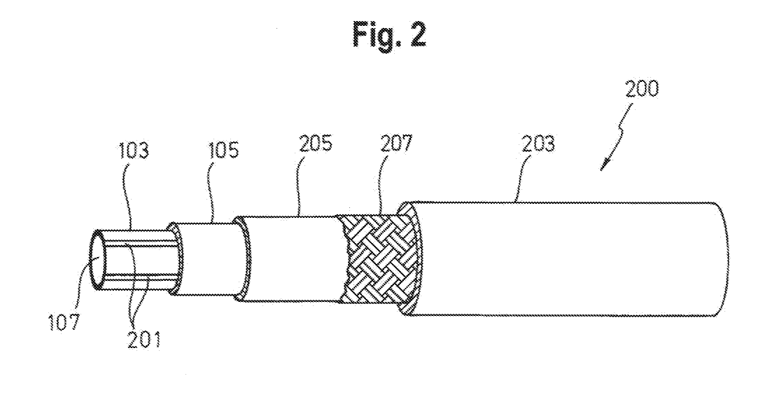

FIG. 2 depicts a further implementation 200 of the hose line. The implementation according to FIG. 2 comprises a first support layer 203, a second support layer 205, and an intermediate layer 207 arranged between the first support layer 203 and the second support layer 205. In order to prevent the diffusion of a fluid flowing within the hose line 200 through the wall of the hose line 200, the hose line further comprises a first barrier layer 103 as well as a second barrier layer 105. The first barrier layer 103 is arranged on the internal side of the hose line 200. The second barrier layer 105 is arranged between the first barrier layer 103 and the second support layer 205.

The intermediate layer 207 arranged between the first support layer 203 and the second support layer 205 is formed as a textile pressure carrier in the depicted implementation. The barrier layer formed as a textile pressure carrier can be braided, spiraled, or knitted, for example, and can contain p-aramid, POD, polyimide and/or PET fibers. The intermediate layer 207 absorbs compressive forces of the fluid flowing within the hose line 200 and can also absorb tensile forces as well as protect the hose line 200 from external mechanical damage, for example so as to prevent leakage; additionally, it also affords the hose line 200 kink resistance. This allows the first support layer 203 and the second support layer 205 to be dimensioned so as to require less material and be of lower weight while simultaneously realizing optimized mechanical properties. The first support layer 203 simultaneously forms the top layer of the hose line 200.

In the implementation depicted in FIG. 2, the first support layer 203 is formed from ethylene acrylate elastomer and the second support layer 205 from epichlorohydrin elastomer. However, other suitable elastomers can also be used, for example acrylonitrile-butadiene elastomer (NBR), chloroprene elastomer, ethylene vinyl acetate elastomer or even chlorinated or chlorosulfonated polyethylene.

In the implementation depicted in FIG. 2, the hose line comprises electrically conductive strips 201. This enables the preventing of an electrical charge, e.g. when fueling, or, respectively, being able to safely discharge electrical charges. The first barrier layer 103 arranged on the internal side 107 of the hose line 200 comprises recesses here in which the electrically conductive strips 201 are arranged.

As in the implementation from FIG. 1, the first barrier layer 103 consists of for example, thermo-plastic fluoroelastomer vulcanizate (F-TPV) and the second barrier layer 105 consists of for example, fluoroelastomer (FPM) in the implementation depicted in FIG. 2. Here as well, the first barrier layer 103 of thermoplastic fluoroelastomer vulcanizate has a layer thickness of 0.28 mm (0.011 in) and the second barrier layer 105 of fluororubber a layer thickness of 1.3 mm (0.051 in). The second barrier layer 105 of fluoroelastomer, which is arranged here between the first barrier layer 103 and the second support layer 205, also forms an adhesion system by means of vulcanization between the first barrier layer 103 of fluoroelastomer vulcanizate and the second support layer 205 of epichlorohydrin elastomer in the implementation shown in FIG. 2 and thereby also yields, additionally to reduced diffusion, production-related advantages.

The implementation of a hose line 200 as shown in FIG. 2 with two barrier layers 103, 105, two support layers 203, 205, and an intermediate layer 207, achieves a sealing of the hose line 200 which meets all the current legal standards regarding reliable diffusion of fuels by fuel-carrying hose lines and, at the same time, achieves high mechanical stability and strength as well as the required protection against damage attributable to external influences, in particular related to the operating conditions of motor vehicles.

One example of a method for producing a hose line 100 for a fluid according to the disclosure comprises the following steps. Providing a support layer 101, providing a first barrier layer 103 configured to prevent the diffusion of the fluid, providing a second barrier layer 105, arranging the second barrier layer 105 on the internal side of the support layer 101, arranging the first barrier layer 103 on the internal side of the second barrier layer 105, as well as joining the support layer 101 to the second barrier layer 105 and joining the second barrier layer 105 to the first barrier layer 103, particularly by vulcanization. The layers can also be joined in another way other than vulcanization, for example by means of an adhesion agent for joining the layers together. It is also conceivable to, for example, join the second barrier layer 105 to the first support layer 101 by adhesion and then join the first barrier layer 103 to the second barrier layer 105 by vulcanization.

One or more of the layers 101, 103, and 105 can be provided by means of extrusion. Thus, for example, the barrier layers 103, 105 can be produced in an extrusion process while the support layer 101 is produced by means of another method. Preferably, however, all three layers 101, 103, and 105 are produced by extrusion. The intermediate layer 207 in the form of a textile pressure carrier can be applied as a braided, knitted, or spiraled layer.

### LIST OF REFERENCE NUMERALS

100 hose line according to a first example
101 support layer
103 first barrier layer
105 second barrier layer
107 internal side of hose line
200 hose line according to a second example
201 electrically conductive strip
203 first support layer
205 second support layer
207 intermediate layer

What is claimed is:

1. A hose line for a fluid, comprising:
a support layer;
a first barrier layer configured to prevent a diffusion of the fluid,
a second barrier layer,
wherein the first barrier layer is arranged on an internal side of the hose line and the second barrier layer is arranged between the first barrier layer and the support layer.

2. The hose line according to claim 1, wherein the first barrier layer arranged on the internal side of the hose line is electrically conductive.

3. The hose line according to claim 1, wherein the hose line further comprises an electrically conductive strip for discharging electrical charge arranged on the internal side of the hose line.

4. The hose line according to claim 3, wherein the first barrier layer arranged on the internal side of the hose line comprises a recess for accommodating the electrically conductive strip.

5. The hose line according to claim 3, wherein the hose line comprises an inner layer o cover the electrically conductive strip on the internal side of the first barrier layer.

6. The hose line according to claim 3, wherein the electrically conductive strip has a radial thickness of between 30 μm and 60 μm.

7. The hose line according to claim 1, wherein the hose line comprises a first support layer, a second support layer arranged in the interior of the hose line relative to the first support layer, and an intermediate layer arranged between the first support layer and the second support layer.

8. The hose line according to claim 7, wherein the intermediate layer is configured as a textile pressure carrier and contains p-aramid, POD, polyamide, and/or PET fibers.

9. The hose line according to claim 7, wherein at least one of the first support layer or the second support layer contains an epichlorohydrin elastomer, art acrylate elastomer, or an ethylene acrylate elastomer.

10. The hose line according to claim 1, wherein one of the barrier layers predominantly comprises a thermoplastic fluoroelastomer vulcanizate and the other of the barrier layers predominantly comprises a fluoroelastomer or a fluororubber.

11. The hose line according to claim 10, wherein the thermoplastic fluoroelastomer vulcanizate exhibits a thermoplastic matrix of fluorine resins in which areas of fluororubber have been vulcanized.

12. The hose line according to claim 10, wherein the barrier layer of thermoplastic fluoroelastomer vulcanizate has a layer thickness between 0.15 mm and 3.0 mm and the barrier layer of thermoplastic fluoroelastomer or fluororubber has a layer thickness between 0.8 mm and 1.5 mm.

13. The hose line according to claim 10, wherein the barrier layer of fluoroelastomer vulcanizate is arranged on the internal side of the hose line and thus forms the first barrier layer, and the barrier layer of fluororubber or fluoroelastomer is arranged adjacent to the barrier layer of thermoplastic fluoroelastomer vulcanizate and thus forms the second barrier layer, and wherein the second barrier layer forms an adhesion system between the first barrier layer and a support layer of epichlorohydrin elastomer, acrylate elastomer or ethylene acrylate elastomer adjoining the second barrier layer by vulcanization.

14. A method for producing a hose line for a fluid, comprising:
arranging a second barrier layer on an internal side of a support layer;
arranging a first barrier layer on the internal side of the second barrier layer, wherein the first barrier layer is configured to prevent diffusion of the fluid;
joining the support layer to the second barrier layer; and
joining the second barrier layer to the first barrier layer.

15. The method according to claim 14, further comprising:
producing one or more of the support layer, the first barrier layer, or the second barrier layer by extrusion.

16. The method according to claim 14, further comprising:
arranging a first support layer and a second support layer on an external side of the second barrier layer, and
arranging an intermediate layer between the first support layer and the second support layer.

17. The method according to claim 16, wherein the intermediate layer is braided, spiraled, or knitted.

18. The method according to claim 14, further comprising:
arranging an electrically conductive strip on an external side of the first barrier layer.

19. The method according to claim 16, further comprising:
joining the first barrier layer to the second support layer through vulcanization.

20. The method according to claim 14, wherein joining the support layer to the second barrier layer and joining the second barrier layer to the first barrier layer comprises vulcanization or use of an adhesion agent.
